(19) United States
(12) Patent Application Publication
(10) Pub. No.: US 2005/0062972 A1
(43) Pub. Date: Mar. 24, 2005

(54) System and method for cavity ring-down spectroscopy using continuously varying continuous wave excitation

(76) Inventor: Calvin R. Krusen, Richboro, PA (US)

Correspondence Address: RATNERPRESTIA, P O BOX 980, VALLEY FORGE, PA, 19482-0980, US

(21) Appl. No.: 10/667,819

(22) Filed: Sep. 22, 2003

(51) Int. Cl. G01N 21/61

(52) U.S. Cl. 356/437

(57) ABSTRACT

An apparatus and method for determining the presence of a trace species in a sample gas contained in a resonant cavity. The apparatus comprises at least one light source for generating radiation; a controller coupled to the at least one light source for controlling a frequency of the radiation, the controller varying the frequency of the radiation over a predetermined frequency range; and a processor coupled to the resonant cavity for determining a level of the trace species within the resonant cavity over the predetermined frequency range.

### FIELD OF THE INVENTION

This invention relates generally to absorption spectroscopy and, in particular, is directed to a method and apparatus for determining the presence of trace species using Cavity Ring-Down Spectroscopy (CRDS) by continually varying the wavelength of laser excitation.

### BACKGROUND OF THE INVENTION

Referring now to the drawing, wherein like reference numerals refer to like elements throughout, FIG. 1 illustrates the electromagnetic spectrum on a logarithmic scale. The science of spectroscopy studies spectra. In contrast with sciences concerned with other parts of the spectrum, optics particularly involves visible and near-visible light—a very narrow part of the available spectrum which extends in wavelength from about 1 mm to about 1 nm. Near visible light includes colors redder than red (infrared) and colors more violet than violet (ultraviolet). The range extends just far enough to either side of visibility that the light can still be handled by most lenses and mirrors made of the usual materials. The wavelength dependence of optical properties of materials must often be considered.

Absorption-type spectroscopy offers high sensitivity, response times on the order of microseconds, immunity from poisoning, and limited interference from molecular species other than the species under study. Various molecular species can be detected or identified by absorption spectroscopy. Thus, absorption spectroscopy provides a general method of detecting important trace species. In the gas phase, the sensitivity and selectivity of this method is optimized because the species have their absorption strength concentrated in a set of sharp spectral lines. The narrow lines in the spectrum can be used to discriminate against most interfering species.

In many industrial processes, the concentration of trace species in flowing gas streams and liquids must be measured and analyzed with a high degree of speed and accuracy. Such measurement and analysis is required because the concentration of contaminants is often critical to the quality of the end product. For example, gases such as N₂, O₂, H₂, Ar, and He are used to manufacture integrated circuits and the presence in those gases of impurities—even at parts per billion (ppb) levels—is damaging and reduces the yield of operational circuits. Therefore, the relatively high sensitivity with which water can be spectroscopically monitored is important to manufacturers of high-purity gases used in the semiconductor industry. Various impurities must be detected in other industrial applications. Further, the presence of impurities, either inherent or deliberately placed, in liquids have become of particular concern of late.

Spectroscopy has obtained parts per million (ppm) level detection for gaseous contaminants in high-purity gases. Detection sensitivities at the ppb level are attainable in some cases. Accordingly, several spectroscopic methods have been applied to such applications as quantitative contamination monitoring in gases, including: absorption measurements in traditional long pathlength cells, photoacoustic spectroscopy, frequency modulation spectroscopy, and intracavity laser absorption spectroscopy. These methods have several features, discussed in U.S. Pat. No. 5,528,040 issued to Lehmann, which make them difficult to use and impractical for industrial applications. They have been largely confined, therefore, to laboratory investigations.

In contrast, continuous wave-cavity ring-down spectroscopy (CW-CRDS) has become an important spectroscopic technique with applications to science, industrial process control, and atmospheric trace gas detection. CW-CRDS has been demonstrated as a technique for the measurement of optical absorption that excels in the low-absorbance regime where conventional methods have inadequate sensitivity. CW-CRDS utilizes the mean lifetime of photons in a high-finesse optical resonator as the absorption-sensitive observable.

Typically, the resonator is formed from a pair of nominally equivalent, narrow band, ultra-high reflectivity dielectric mirrors, configured appropriately to form a stable optical resonator. A laser pulse is injected into the resonator through a mirror to experience a mean lifetime which depends upon the photon round-trip transit time, the length of the resonator, the absorption cross section and number density of the species, and a factor accounting for intrinsic resonator losses (which arise largely from the frequency-dependent mirror reflectivities when diffraction losses are negligible). The determination of optical absorption is transformed, therefore, from the conventional power-ratio measurement to a measurement of decay time. The ultimate sensitivity of CW-CRDS is determined by the magnitude of the intrinsic resonator losses, which can be minimized with techniques such as superpolishing that permit the fabrication of ultra-low-loss optics.

FIG. 2 illustrates a conventional CW-CRDS apparatus 200. As shown in FIG. 2, light is generated from a narrow band, tunable, continuous wave diode laser 202. Laser 202 has a wavelength fixed so as to correspond to the desired spectral line of the analyte. An acousto-optic modulator (AOM) 204 is positioned in front of and in line with the radiation emitted from laser 202. AOM 204 provides a means for providing light 206 from laser 202 along the optical axis 219 of resonant cavity 218. Light 206 exits AOM 204 and is directed by mirrors 208, 210 to cavity mirror 220 as light 206a. Light travels along optical axis 219 and exponentially decays between cavity mirrors 220 and 222. The measure of this decay is indicative of the presence or lack thereof of a trace species. Detector 212 is coupled between the output of optical cavity 218 and controller 214. Controller 214 is coupled to laser 202, processor 216, and AOM 204. Processor 216 processes signals from optical detector 212 in order to determine the level of trace species in optical resonator 218.

In CW-CRDS, typically, a first order light beam 206 is aligned along with optical axis 219 of cavity 218 incident on the cavity in-coupling mirror 220, and a zero order beam 224 is idled with a different optical path (other higher order beams are very weak and thus not addressed). Thus, AOM 204 controls the direction of beams 206, 224.

When AOM 204 is on, most light power (typically, up to 80%, depending on size of the beam, crystals within AOM 204, alignment, etc.) goes to the first order along optical axis 219 of resonant cavity 218 as light 206. The remaining beam power goes to the zero order (light 224), or other higher orders. The first order beam 206 is used for the input coupling light source; the zero order beam 224 is typically idled or used for diagnostic components. Once light energy is built up within the cavity, AOM 204 is turned off. This results in all the beam power going to the zero order as light 224, and no light 206 is coupled into resonant cavity 218. The stored light energy inside the cavity follows an exponential decay (ring down).

As discussed, these conventional systems fix the wavelength of the laser to the apex of a single absorption peak within the absorption spectrum of the gas being analyzed. As such, these systems are unable to detect more than one trace species at a time nor are they able to compensate for interfering species from other analytes.

Further, conventional CW-CRDS requires prior knowledge of the spectral line shapes to make accurate calculations. This is most apparent when the carrier gas changes the line width of the absorption spectrum of the analyte. Without prior measurements of the absorption line width changes, the concentration of the gas can not be accurately calculated. In the presence of more than one absorber at or near the wavelength of interest, CW-CRDS is unable to distinguish between the absorption of the target analyte and the absorption of interfering analytes.

In another prior art system, a pulse laser may be used in order to take a “snap shot” of the entire spectrum of interest. These systems also have disadvantages in that pulse lasers are expensive and difficult to work with. Additionally, this “snap shot” approach lacks adequate resolution necessary to meet today's high sensitivity requirements.

To overcome the shortcomings of conventional systems, an improved system and method for measuring a sample gas for analytes across a broad frequency spectrum is provided.

### SUMMARY OF THE INVENTION

To achieve that and other objects, and in view of its purposes, the present invention provides an improved apparatus and method for determining the presence of a trace species in a sample gas contained in a resonant cavity. The apparatus includes at least one light source for generating radiation; a controller coupled to the at least one light source for controlling a frequency of the radiation, the controller varying the frequency of the radiation over a predetermined frequency range; and a processor coupled to the resonant cavity for determining a level of absorption within the resonant cavity over the predetermined frequency range, the absorption being indicative of a level of trace species.

According to another aspect of the invention, the controller controls a temperature of the at least one light source and/or a current supplied to the at least one light source.

According to a further aspect of the invention, the controller varies the frequency of at least one light source over a predetermined time period based on one or both of the temperature and the current.

According to yet another aspect of the invention, the temperature and/or the current are varied at a substantially constant rate over the predetermined time period.

According to still another aspect of the invention, a profile of the temperature has a leading edge slope and a trailing edge slope that are substantially identical.

According to yet a further aspect of the invention, the temperature and/or current are repeatedly swept over a predetermined range.

A method aspect of the invention comprises the steps of generating radiation from at least one light source; coupling the radiation into an input of the resonant cavity; controlling a frequency of the radiation of the at least one light source; varying the frequency of the radiation over a predetermined frequency range; and determining a level of the trace species within the resonant cavity over the predetermined frequency range.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 illustrates the electromagnetic spectrum on a logarithmic scale;

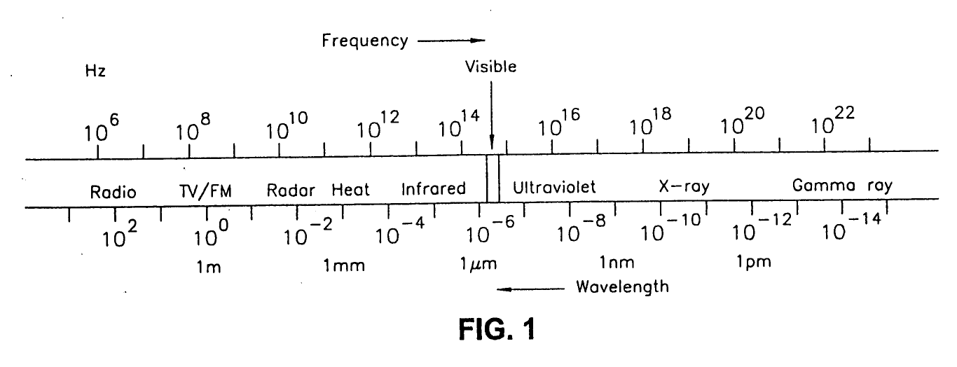

FIG. 2 illustrates a prior art CW-CRDS system;

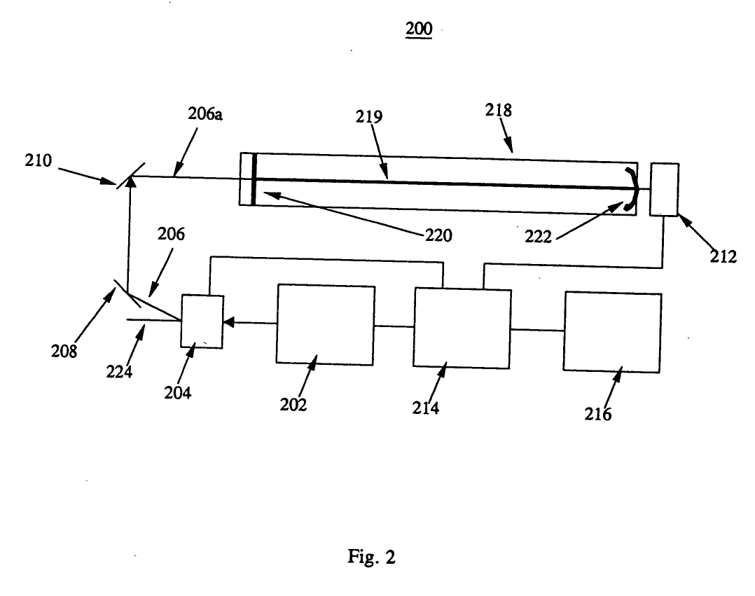

FIG. 3 illustrates a block diagram of an exemplary embodiment of the present invention;

FIG. 4 is a graph illustrating the variance of laser wavelength and laser temperature over time;

FIG. 5 is a graph illustrating ring-down rate over time according to an exemplary embodiment of the present invention;

FIG. 6 is a graph illustrating ring-down rate versus laser temperature according to an exemplary embodiment of the present invention;

FIG. 7 is a graph illustrating ring-down rate versus wavelength according to an exemplary embodiment of the present invention; and

FIG. 8 is a graph illustrating an example of overlapping spectra of two trace species according to an exemplary embodiment of the present invention.

### DETAILED DESCRIPTION OF THE INVENTION

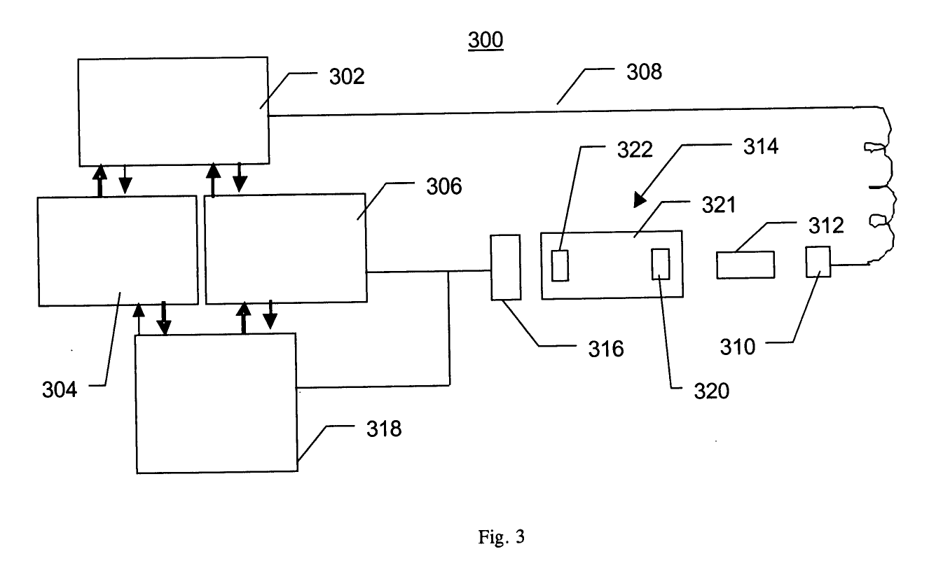

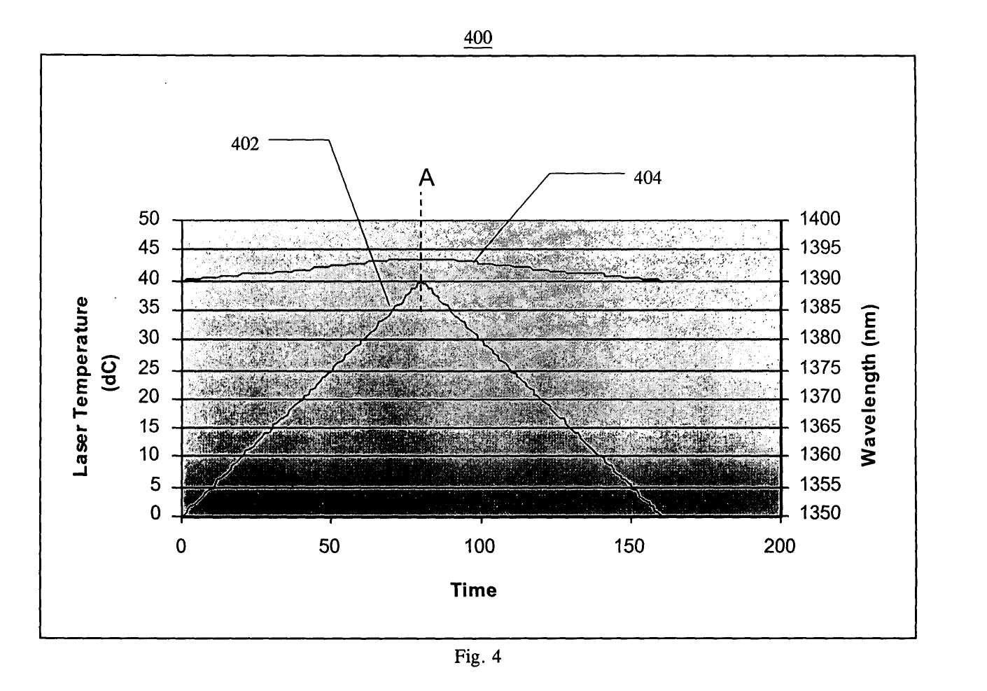

FIG. 3 illustrates an exemplary embodiment of the present invention. As shown in FIG. 3, light is generated from light source 302, such as a narrow band, tunable, continuous wave diode laser. Light source 302 is coupled to, and controlled and tuned by, temperature controller 304 and current controller 306. In an exemplary embodiment, temperature controller 304 is used to adjust the wavelength of light source 302. In one exemplary embodiment, temperature controller 304 continuously adjusts the wavelength of light source 302 such that the frequency output sweeps through a predetermined frequency range. This is illustrated in FIG. 4, for example. As shown in FIG. 4, graph 400 plots the temperature (in Celsius) of light source 302 over a predetermined time period t as curve 402. The resultant frequency output is plotted as curve 404. As shown, as the temperature increases from about 0 degrees C. to about 40 degrees C., the frequency output of light source 302 sweeps at a substantially constant rate from about a wavelength of 1390 nm to about 1394 nm. As a result, more than one analyte is susceptible to detection. Also note that once temperature reaches a peak value at point “A,” the temperature is reduced. Accordingly, the frequency is reduced as well. In other words, both the temperature plot 402 and the frequency plot 404 are substantially symmetric about point “A.”

As shown, the pattern of the temperature profile has a triangular pattern. The invention is not so limited, however, in that the temperature profile may include other patterns, such as a sawtooth pattern for example.

Referring again to FIG. 3, light energy from light source 302 is coupled to emitter 310 through optical fiber 308. Although an optical fiber 308 is illustrated in the exemplary embodiment, the invention is not so limited. It is also contemplated that other means for coupling light output from laser 302 may be used, such as open air coupling, for example, either directly or using optical couplers. Light energy is, in turn, provided to optional optical isolator 312 and coupled into resonant cavity 314. Detector 316 is coupled to the output of optical cavity 314. Output signals, representing the ring-down within resonant cavity 314, are provided to processor 318 and current controller 306. Processor 318 is coupled to temperature controller 304 and current controller 306. The rate of sweep, temperature and/or current of light source 302 is under control of processor 318. Processor 318, such as a personal computer or other specialized processor may also process signals from optical detector 316 in order to determine the level of trace species (analyte) in optical resonator 314. Alternatively, a separate analysis system (not shown) may be used to determine the level of trace species in the sample gas.

Preferably, light source 302 is a narrow line-width radiation semiconductor laser operating in the visible to near- and middle-infrared spectrum. Alternatively, light source 302 may be an external-cavity semiconductor diode laser. In an exemplary embodiment, resonant cavity 314 comprises at least a pair of high reflectivity mirrors 320, 322 and a gas cell 321 on which the mirrors are mounted. Cell 321 can be a flow cell, a vacuum cell, or an open path cell for example. Detector 316 may be a photovoltaic detector, such as photodiodes or photo-multiplier tubes (PMT), for example. Although mirrors 320, 322 are referred to above the invention is no so limited as it is contemplated that retroreflective prisms, such as those described in U.S. Pat. No. 5,973,864 to Lehmann et al., may be used.

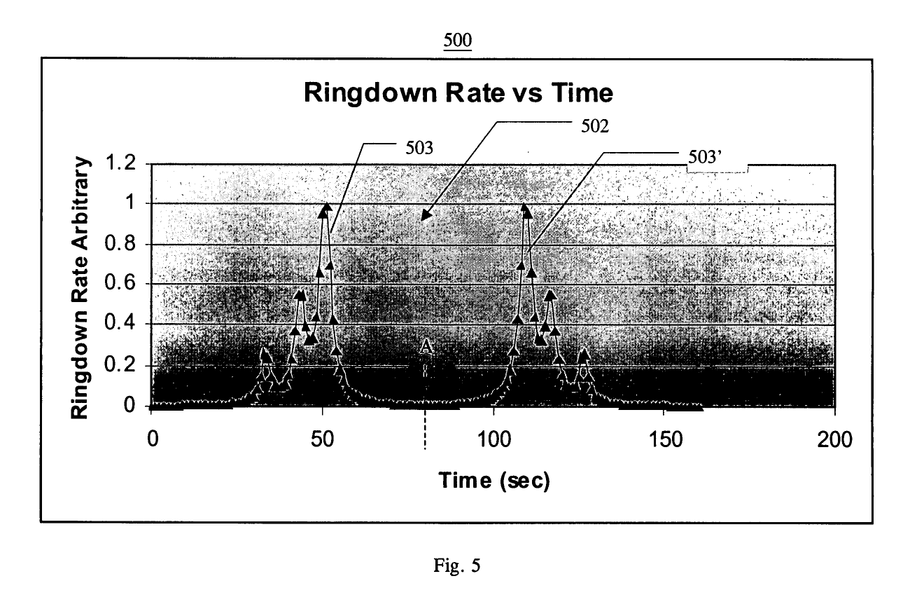

FIG. 5 illustrates ring-down rate versus time according to an exemplary embodiment of the present invention. As shown in FIG. 5, as the frequency of light source 302 is varied the ring-down rate changes. Also note, that portions 503 and 503′ of plot 502 are mirror images of one another about point “A.” Again, this is due to the reciprocal nature of temperature control of light source 302. Although the exemplary embodiment illustrates that the temperature is varied both upwards and downwardly during measurement of trace species, the invention is not so limited. It is also possible to conduct measurements on either the rising edge or trailing edge of the temperature if desired. By measuring on both the rising and trailing edges, however, additional accuracy may be obtained.

It is also important to note that the rate of temperature change may effect the quality of the ring-down measurements. It is important to allow light source 302 to stabilize at each temperature in order to provide a stable output frequency. Once the output of light source 302 has stabilized, a corresponding ring-down rate is processed. Also, when conducting measurements on both the rising and trailing edges discussed above, hysteresis effects should be considered.

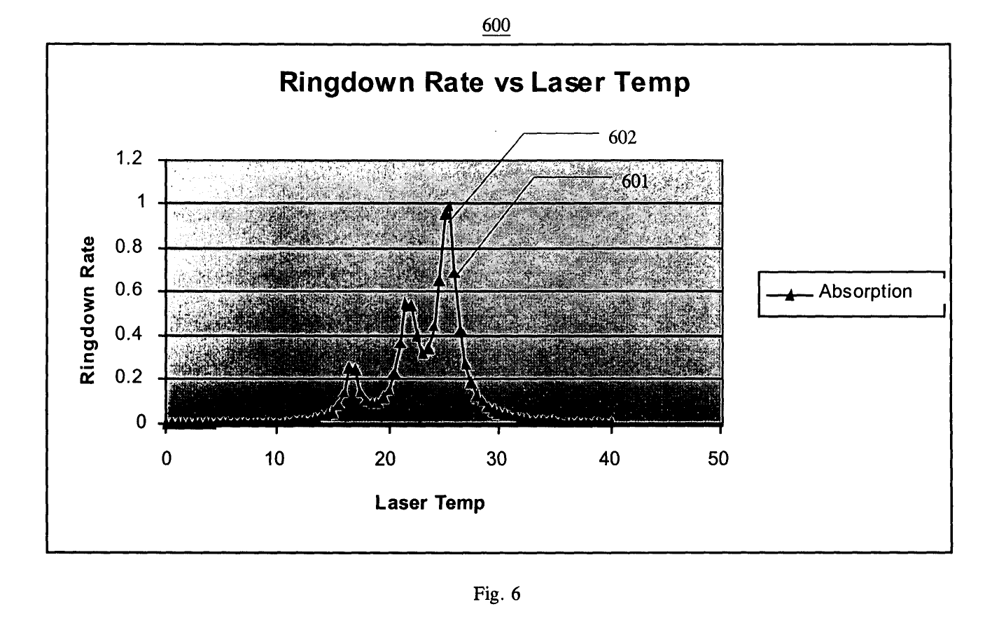

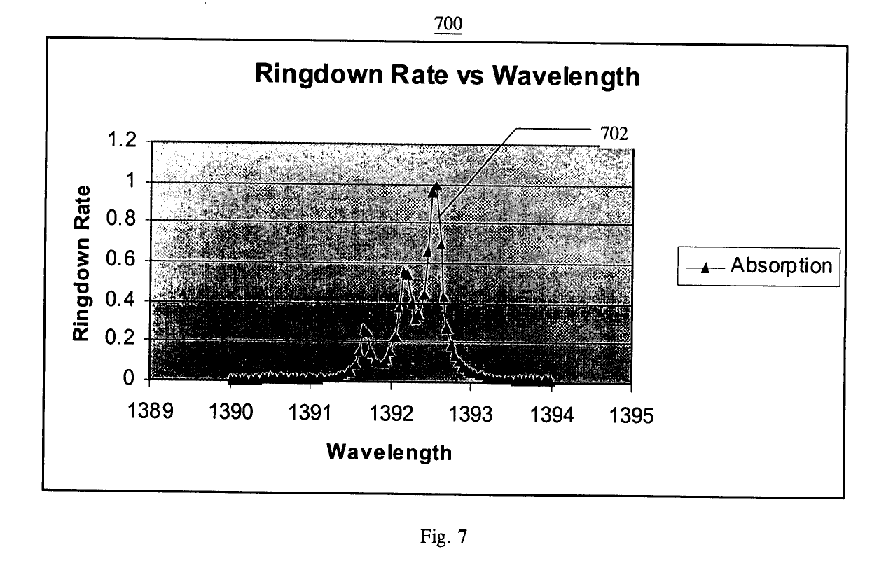

Referring now to FIG. 6, a plot 602 illustrating ring-down rate versus temperature is shown. As shown, various points 601 representing ring-down rates at respective wavelengths are plotted. Thus, over time the array of data points 601 yield plot 602 which represents the absorption spectrum of interest. Plot 602 may be easily converted into a plot representing ring-down rate versus wavelength and is illustrated in FIG. 7.

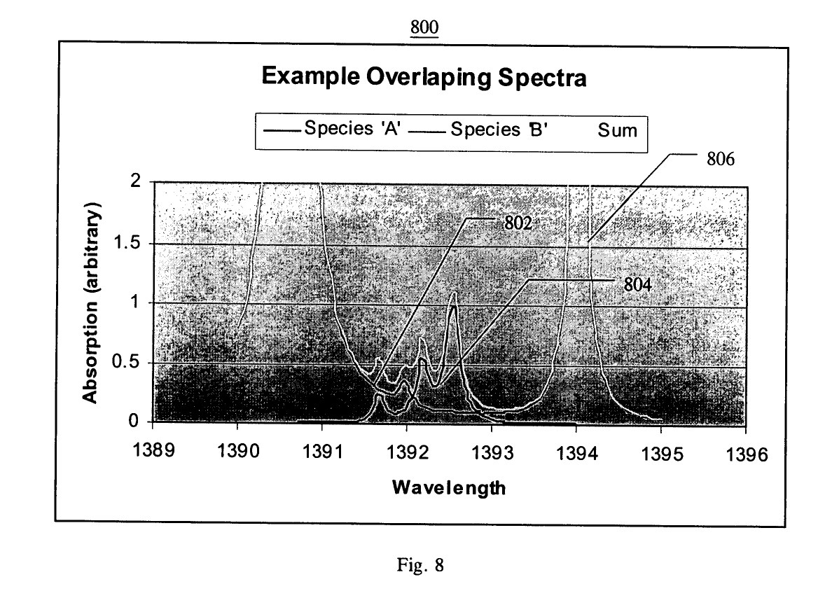

As shown in Eq. 1, the absorption spectra will be the sum of transmission losses of the system and the absorption of the radiation with respect to wavelength.

$$\begin{matrix}Eq . 1 \text{:} \\ y ( t ) = {y}_{0} + mt + {\sum }_{i} \frac{{a}_{i}}{1 + {( \frac{t - {t}_{i}}{{b}_{i}} )}^{2}}\end{matrix}$$

where
y(t) is the sum of Lorentzian peaks and a linear baseline;
t is the temperature of the laser, directly proportional to the laser wavelength;
y₀ is the constant baseline offset;
m is the slope of the baseline;
aᵢ is the amplitude of the i^{th} lorentzian peak;
tᵢ is the center of the i^{th} lorentzian peak; and
bᵢ is the width of the i^{th} lorentzian peak.
   The absorption spectrum can then be analyzed to determine the individual components. This can be done by comparing the acquired spectrum against a library of known spectra. Since the spectrum of the analyte being measured is usually known, the acquired spectrum can be compared to the known spectrum to determine if interferences exist. An example of this is illustrated in FIG. 8. If the quantities of interfering spectra are known, they may be subtracted from the acquired spectra to increase resolution. As shown in FIG. 8, the plot obtained by CRDS is plot 806, which is the sum of interfering species A (plot 802) and desired species B (plot (804). In this example, the spectrum of interfering species A is known. As such, it may be subtracted from plot 806 to yield the desired plot 804 for species B.

In addition to correcting for interfering spectra, having sufficient data to calculate the line shape increases accuracy by including factors such as pressure broadening in the concentration calculations.

In the exemplary embodiment described above, a single light source 302 is illustrated. The invention is not so limited, as it is contemplated that multiple light sources may be used as desired, each coupled to a respective controller and detector. The use of multiple light sources will be able to extend the frequency range of the system, thus enabling the detection of additional trace species otherwise undetectable with a single laser system.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

1. An apparatus for determining the presence of a trace species in a sample gas contained in a resonant cavity, the apparatus comprising:
at least one light source for generating radiation;
a controller coupled to the at least one light source for controlling a frequency of the radiation, the controller varying the frequency of the radiation over a predetermined frequency range; and
a processor coupled to the resonant cavity for determining a level of absorption within the resonant cavity over the predetermined frequency range.

2. The apparatus according to claim 1, wherein the controller varies the frequency of the at least one light source over a predetermined time period.

3. The apparatus according to claim 2, wherein the frequency is varied at a substantially constant rate over the predetermined time period.

4. The apparatus according to claim 2, wherein a profile of the frequency is one of a sawtooth wave pattern and a triangle pattern.

5. The apparatus according to claim 2, wherein a profile of the frequency has a leading edge slope and a trailing edge slope that are substantially identical.

6. The apparatus according to claim 1, wherein the controller varies the frequency of the at least one light source based on a temperature of the at least one light source.

7. The apparatus according to claim 6, wherein the frequency is varied at a substantially constant rate over the predetermined time period.

8. The apparatus according to claim 6, wherein an initial temperature is about 0 degrees Centigrade.

9. The apparatus according to claim 6, wherein a profile of the temperature is one of a sawtooth wave pattern and a triangle pattern.

10. The apparatus according to claim 6, wherein a profile of the temperature has a leading edge slope and a trailing edge slope that are substantially identical.

11. The apparatus according to claim 6, wherein the frequency of the radiation is proportional to the temperature.

12. The apparatus according to claim 6, wherein the temperature is repeatedly swept over a predetermined range.

13. The apparatus according to claim 1, wherein the controller controls a current supplied to the at least one light source.

14. The apparatus according to claim 13, wherein the controller varies the frequency of the at least one light source over a predetermined time period based on the current.

15. The apparatus according to claim 14, wherein the current is varied at a substantially constant rate over the predetermined time period.

16. The apparatus according to claim 13, wherein a profile of the current is one of a sawtooth wave pattern and a triangle pattern.

17. The apparatus according to claim 13, wherein a profile of the current has a leading edge slope and a trailing edge slope that are substantially identical.

18. The apparatus according to claim 1, wherein the processor determines an absorption spectrum of the sample gas based on a ring-down rate of the radiation within the resonant cavity.

19. The apparatus according to claim 1, wherein the level of the trace species is a plurality of levels taken at respective frequencies of the light source.

20. The apparatus according to claim 1, wherein the at least one light source is a plurality of light sources, each generating a respective radiation output.

21. The apparatus according to claim 1, further comprising a coupler for coupling the radiation into an input of the resonant cavity.

22. The apparatus according to claim 1, wherein the controller controls both a temperature of the at least one light source and a current supplied to the at least one light source.

23. A system for determining the presence of a trace species in a sample gas, the system comprising:
a resonant cavity containing at least a portion of the sample gas;
at least one light source for generating radiation;
a coupler for coupling the radiation into the resonant cavity;
a controller coupled to the at least one light source for controlling a frequency of the radiation based on at least one of a temperature of the light source and a current supplied to the light source, the controller varying the temperature and/or the current of the light source over a predetermined range; and
a processor coupled to the resonant cavity for determining a level of the trace species within the resonant cavity over the frequency.

24. The system according to claim 23, wherein at least one of the temperature and the current are varied at a substantially constant rate over a predetermined time period.

25. The system according to claim 23, wherein the processor determines an absorption spectrum of the sample gas based on a ring-down rate of the radiation within the resonant cavity.

26. A method for determining the presence of a trace species in a sample gas contained in a resonant cavity, the method comprising the steps of:
a) generating radiation from at least one light source;
b) coupling the radiation into an input of the resonant cavity;
c) controlling a frequency of the radiation of the at least one light source;
d) varying the frequency of the radiation over a predetermined frequency range; and
e) determining a level of the trace species within the resonant cavity over the predetermined frequency range.

27. The method according to claim 26, further comprising the step of:
repeatedly varying the frequency of the light source over the predetermined frequency range.

28. The method according to claim 26, wherein the controlling step c) further comprises at least one of the steps of:
controlling a temperature of the light source; and
controlling a current provided to the light source.

29. An apparatus for determining the presence of a trace species in a sample gas contained in a resonant cavity comprising:
means for generating radiation from at least one light source;
means for coupling the radiation into an input of the resonant cavity;
means for controlling a frequency of the radiation of the at least one light source;
means for varying the frequency of the radiation over a predetermined frequency range; and
means for determining a level of the trace species within the resonant cavity over the predetermined frequency range.
